(19) United States
(12) Patent Application Publication
(10) Pub. No.: US 2012/0090112 A1
(43) Pub. Date: Apr. 19, 2012

(54) WET WIPES, ARTICLES OF MANUFACTURE, AND METHODS FOR MAKING SAME

(76) Inventors: Michael Edward Carrier, Green Township, OH (US); John Allen Manifold, Sunman, IN (US); Khosrow Parviz Mohammadi, Liberty Township, OH (US); Kevin Mitchell, West Chester, OH (US)

(21) Appl. No.: 13/272,729

(22) Filed: Oct. 13, 2011

Related U.S. Application Data
(60) Provisional application No. 61/393,094, filed on Oct. 14, 2010.

(51) Int. Cl. A47L 25/00; B05D 3/00; B05D 7/00

(52) U.S. Cl. 15/104.93; 427/8

(57) ABSTRACT

Dispersible wet wipes, method for making same and articles of manufacture housing same are provided.

### CROSS REFERENCE TO RELATED APPLICATION(S)

This application claims the benefit of U.S. Provisional Application No. 61/393,094, filed Oct. 14, 2010.

### FIELD OF THE INVENTION

The present invention relates to wet wipes and more particularly to dispersible wet wipes, method for making same and articles of manufacture housing same.

### BACKGROUND OF THE INVENTION

Wet wipes, such as wet wipes, are well known in the art. The wet wipes comprise a liquid composition, such as a lotion. Such wet wipes employ various technologies depending upon whether the wet wipes are going to be disposed in a sewer or septic system, such as by flushing the wet wipe down a toilet or not.

Wet wipes comprising a blend of pulp fibers and synthetic fibers, such as rayon and/or lyocell, and optionally with thermoplastic bonding fibers are known in the art.

Further, wet wipes comprising 100% pulp fibers are also known in the art, however such wet wipes utilize permanent wet strength agents to achieve wet strength necessary in the wet wipes. As a result such 100% pulp fiber wet wipes have in the past performed less than acceptable with respect to dispersibility.

Known technologies that have been employed in wet wipes to achieve some level of dispersibility albeit less than desirable dispersibility include ion triggerable polymers that bind the fibers together within the wet wipes. Such ion triggerable polymers exhibit good bonding strength under high ion/salt environments, but lose their bonding strength when exposed to excessive amounts of water, such as in a toilet bowl and/or sewer or septic systems.

Another technology that is known in the art is temperature and/or pH sensitive polymer binders that bind the fibers of the wet wipe together. Such temperature or pH sensitive polymers exhibit good bonding strength under certain temperature and/or pH conditions, but lose their bonding strength when exposed to certain temperature and/or pH conditions.

Still another technology that has been used in wet wipes is hydroentanglement (also known as spunlaced). Hydroentangling entangles the fibers of the wet wipe to give the wet wipe strength. Such a hydroentangled wet wipe is intended to disentangle when exposed to mild agitation and thus lose its strength rather quickly.

Another technology that has been used in wet wipes to increase dispersibility of the wet wipe is mechanical weakening. Such mechanical weakening includes embossing the fibrous structure (before and/or after application of the liquid composition) with a high pressure embossing process such that regions of the fibrous structure are glassined.

Even in light of all these known technologies and combinations thereof, there is still a need for improved dispersibility of wet wipes compared to the dispersibility of known wet wipes.

### SUMMARY OF THE INVENTION

The present invention fulfills the need described above by providing a novel wet wipe that exhibits improved dispersibility as measured according to the Shake Flask Test Method described herein compared to the dispersibility as measured according to the Shake Flask Test Method described herein of known wet wipes.

In one example of the present invention, a wet wipe that exhibits a 12.5 mm Screen Retention Value at 3 hours of less than 20% and a 3 mm Screen Retention Value at 3 hours of less than 25% as measured according to the Shake Flask Test Method described herein, is provided.

In another example of the present invention, a method for making a wet wipe, the method comprising the steps of:
a. providing a fibrous structure; and
b. contacting the fibrous structure with a liquid composition such that a wet wipe that exhibits a 12.5 mm Screen Retention Value at 3 hours of less than 20% and a 3 mm Screen Retention Value at 3 hours of less than 20% as measured according to the Shake Flask Test Method described herein, is provided.

In yet another example of the present invention, a container comprising a wet fibrous structure that exhibits a 12.5 mm Screen Retention Value at 3 hours of less than 20% and a 3 mm Screen Retention Value at 3 hours of less than 25% as measured according to the Shake Flask Test Method described herein, is provided.

Accordingly, the present invention provides a wet wipe that exhibits improved dispersibility compared to known wet wipes, a method for making same, and a container containing same.

### BRIEF DESCRIPTION OF THE DRAWINGS

FIG. 1 is a schematic representation of an example of a fibrous structure in accordance with the present invention;

FIG. 2 is a cross-sectional view of FIG. 1 taken along line 2-2;

FIG. 3 is a schematic representation of another example of a fibrous structure in accordance with the present invention;

FIG. 4 is a cross-sectional view of FIG. 3 taken along line 4-4;

FIG. 5 is a schematic representation of an example of a fibrous structure in accordance with the present invention; and

FIG. 6 is a cross-sectional view of FIG. 5 taken along line 6-6.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structure of the present invention include paper, fabrics (including woven, knitted, and non-woven), and absorbent pads (for example for diapers or feminine hygiene products).

Non-limiting examples of processes for making fibrous structures include known wet-laid papermaking processes, air-laid papermaking processes, and other nonwoven making processes such as meltblowing, spunbonding, and carding. Such wet-laid and/or air-laid papermaking processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a wet wipe is formed.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking. Non-limiting examples of suitable hardwood pulp fibers include eucalyptus and acacia. Non-limiting examples of suitable softwood pulp fibers include Southern Softwood Kraft (SSK) and Northern Softwood Kraft (NSK).

“Hardwood pulp fiber” as used herein means pulp fibers obtained from deciduous trees. Non-limiting examples of deciduous trees include Northern hardwood trees and tropical hardwood trees. Non-limiting examples of hardwood pulp fibers include hardwood pulp fibers obtained from a fiber source selected from the group consisting of Acacia, Eucalyptus, Maple, Oak, Aspen, Birch, Cottonwood, Alder, Ash, Chemy, Elm, Hickory, Poplar, Gum, Walnut, Locust, Sycamore, Beech, Catalpa, Sassafras, Gmelina, Albizia, Anthocephalus, Magnolia, and mixtures thereof. In one example, the hardwood pulp fiber of the present invention is obtained from Eucalyptus.

“Tropical hardwood pulp fiber” as used herein means pulp fibers obtained from a tropical hardwood tree. Non-limiting examples of tropical hardwood trees include Eucalyptus trees and/or Acacia trees.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

In addition, trichomes such as from “lamb's ear” plants and seed hairs can also be utilized in the fibrous structures of the present invention.

In one example, the fibrous structure may comprise 100% by weight on a dry fiber basis of softwood fibers, such as NSK fibers. In another example, the fibrous structure may comprise a mixture of softwood fibers, such as NSK fibers, and hardwood fibers, such as Eucalyptus fibers. In still another example, the fibrous structure may comprise less than 100% and/or less than 90% and/or less than 80% and/or to about 70% by weight on a dry fiber basis of softwood fibers, such as NSK fibers, and greater than 0% and/or greater than 10% and/or greater than 20% and/or to about 30% by weight on a dry fiber basis of hardwood fibers, such as Eucalyptus fibers.

In still another example, the fibrous structure may comprise greater than 0% and/or greater than 5% and/or greater than 10% and/or greater than 20% and/or greater than 30% and/or to about 50% by weight on a dry fiber basis of fibers, such as pulp fibers, that exhibit a mean fiber length of from less than 1 mm and/or less than 0.9 mm and/or less than 0.8 mm and/or to about 0.5 mm and/or to about 0.6 mm and/or to about 0.7 mm.

“Wet wipe” as used herein means a fibrous structure that contains greater than 20% and/or greater than 40% and/or greater than 50% and/or greater than 75% by weight of the wet wipe of a liquid composition. In one example, the fibrous structure of the present invention comprises a % saturation of greater than 50% and/or greater than 75% and/or greater than 100% and/or greater than 125% and/or greater than 150% and/or to about 1000% and/or to about 500% and/or to about 400% and/or to about 300% and/or to about 250% and/or to about 200%.

The liquid composition may be added to the fibrous structure to form a wet wipe prior to and/or after packaging and/or prior to and/or after folding, if any, and/or prior to and/or after any post processing operation, such as embossing, tuft generating, printing, combining with other fibrous structure plies and mixtures thereof. The wet wipe is typically packaged in a moisture impervious container and/or wrapper. The wet wipe may be in the form of one or more individual sheets, such as a stack of sheets, which may be interleaved. In another example, the wet wipes of the present invention may be in the form of wet wipe rolls. Such wet wipe rolls may comprise a plurality of connected, but perforated sheets of fibrous structure, that are separably dispensable from adjacent sheets.

The fibrous structure, as described above, may be utilized to form a wet wipe. “Wet wipe” may be a general term to describe a piece of material, generally fibrous structure, used in cleansing hard surfaces, food, inanimate objects, toys and body parts. In particular, many currently available wet wipes may be intended for the cleansing of the perianal area after defecation. Other wet wipes may be available for the cleansing of the face or other body parts. Multiple wipes may be attached together by any suitable method to form a mitt.

The fibrous structure from which a wet wipe is made should be strong enough to resist tearing during normal use, yet still provide softness to the user's skin, such as a child's tender skin. Additionally, the fibrous structure should be at least capable of retaining its form for the duration of the user's cleansing experience.

Wet wipes may be generally of sufficient dimension to allow for convenient handling. Typically, the wipe may be cut and/or folded to such dimensions as part of the manufacturing process. In some instances, the wipe may be cut into individual portions so as to provide separate wipes which are often stacked and interleaved in consumer packaging. In other embodiments, the wipes may be in a web form where the web has been slit and folded to a predetermined width and provided with means (e.g., perforations) to allow individual wipes to be separated from the web by a user. Suitably, an individual wipe may have a length between about 100 mm and about 250 mm and a width between about 140 mm and about 250 mm. In one embodiment, the wipe may be about 200 mm long and about 180 mm wide. The material of the wipe may generally be soft and flexible, potentially having a structured surface to enhance its cleaning performance.

The wet wipes may also be treated to improve the softness and texture thereof by processes such as hydroentanglement or spunlacing. The wet wipes may be subjected to various treatments, such as, but not limited to, physical treatment, such as ring rolling, as described in U.S. Pat. No. 5,143,679; structural elongation, as described in U.S. Pat. No. 5,518,801; consolidation, as described in U.S. Pat. Nos. 5,914,084, 6,114,263, 6,129,801 and 6,383,431; stretch aperturing, as described in U.S. Pat. Nos. 5,628,097, 5,658,639 and 5,916,661; differential elongation, as described in WO Publication No. 2003/0028165A1; and other solid state formation technologies as described in U.S. Publication No. 2004/0131820A1 and U.S. Publication No. 2004/0265534A1 and zone activation and the like; chemical treatment, such as, but not limited to, rendering part or all of the substrate hydrophobic, and/or hydrophilic, and the like; thermal treatment, such as, but not limited to, softening of fibers by heating, thermal bonding and the like; and combinations thereof.

The wet wipe may have a basis weight of at least about 40 grams/m². In one example, the wipe may have a basis weight of at least about 45 grams/m². In another example, the wet wipe basis weight may be less than 120 grams/m². In another example, wet wipe may have a basis weight of from about 45 grams/m² to about 90 grams/m² and/or from about 50 g/m² to about 80 g/m².

In one example of the present invention the surface of wet wipe may be essentially flat. In another example of the present invention the surface of the wet wipe may optionally contain raised and/or lowered portions. These can be in the form of logos, indicia, trademarks, geometric patterns, images of the surfaces that the substrate is intended to clean (i.e., infant's body, face, etc.). They may be randomly arranged on the surface of the wipe or be in a repetitive pattern of some form.

In another example of the present invention the wet wipe may be biodegradable. For example the wet wipe could be made from a biodegradable material such as a polyesteramide, or high wet strength cellulose.

“Liquid composition” as used herein means any liquid including, but not limited to a pure liquid such as water, an aqueous composition, a colloid, an emulsion, a suspension, a solution and mixtures thereof. The term “aqueous composition” as used herein refers to a composition that comprises at least 20% and/or at least 40% and/or at least 50% and/or to about 98% and/or to about 95% and/or to about 93% and/or to about 90% by weight water.

In one example, the liquid composition comprises water or another liquid solvent. Generally the liquid composition is of sufficiently low viscosity to impregnate the entire structure of the fibrous structure. In another example, the liquid composition may be primarily present on a surface of the fibrous structure surface and to a lesser extent in the inner structure of the fibrous structure. In a further example, the liquid composition is releasably carried by the fibrous structure, that is the liquid composition is carried on or in the fibrous structure and is readily releasable from the fibrous structure by applying some force to the fibrous structure, for example by wiping a surface, such as a human skin, with the fibrous structure.

The liquid composition of the present invention may comprise an oil-in-water emulsion. In one example, the liquid composition of the present invention comprises at least 80% and/or at least 85% and/or at least 90% and/or at least 95% by weight water.

When present on and/or in the fibrous structure of the present invention, the liquid composition may be present at a level of from about 10% to about 1000% of the basis weight of the fibrous structure and/or from about 100% to about 700% of the basis weight of the fibrous structure and/or from about 200% to about 400% of the basis weight of the fibrous structure.

The liquid composition may comprise an acid. Non-limiting examples of acids that can be used in the liquid composition of the present invention are adipic acid, tartaric acid, citric acid, maleic acid, malic acid, succinic acid, glycolic acid, glutaric acid, malonic acid, salicylic acid, gluconic acid, polymeric acids, phosphoric acid, carbonic acid, fumaric acid and phthalic acid and mixtures thereof. Suitable polymeric acids can include homopolymers, copolymers and terpolymers, and may contain at least 30 mole % carboxylic acid groups. Specific examples of suitable polymeric acids useful herein include straight-chain poly(acrylic) acid and its copolymers, both ionic and nonionic, (e.g., maleic-acrylic, sulfonic-acrylic, and styrene-acrylic copolymers), those cross-linked polyacrylic acids having a molecular weight of less than about 250,000, preferably less than about 100,000 poly (α-hydroxy) acids, poly (methacrylic) acid, and naturally occurring polymeric acids such as carageenic acid, carboxy methyl cellulose, and alginic acid. In one example, the liquid composition comprises citric acid and/or citric acid derivatives.

The liquid composition may also contain salts of the acid or acids, which may help to lower the pH of the liquid composition, or another weak base to impart buffering properties to the fibrous structure. The buffering response is due to the equilibrium which is set up between the free acid and its salt. This allows the fibrous structure to maintain its overall pH despite encountering a relatively high amount of bodily waste as would be found post urination and/or defecation in a baby or adult. In one embodiment the acid salt comprises sodium citrate. The amount of sodium citrate present in the liquid composition in one example may be between 0.01 and 2.0%, alternatively 0.1 and 1.25%, or alternatively 0.2 and 0.7% by weight of the liquid composition.

In addition to the above ingredients, the liquid composition may comprise additional ingredients. Non-limiting examples of additional ingredients that may be present in the liquid composition of the present invention include: skin conditioning agents (emollients, humectants) including, waxes such as petrolatum, cholesterol and cholesterol derivatives, di and tri-glycerides including sunflower oil and sesame oil, silicone oils such as dimethicone copolyol, caprylyl glycol and acetoglycerides such as lanolin and its derivatives, emulsifiers; alcohols; preservatives; stabilizers; surfactants including anionic, amphoteric, cationic and non ionic surfactants, colorants, chelating agents including EDTA, sun screen agents, solubilizing agents, perfumes, opacifying agents, vitamins, viscosity modifiers; such as xanthan gum, astringents and external analgesics.

In one example, the liquid composition comprises an alcohol, such as benzylalcohol.

In one example, the liquid composition comprises a perfume.

In one example, the liquid composition comprises a preservative. In another example, the liquid composition is void of a preservative.

The liquid composition prior to contacting the fibrous structure of the present invention may exhibit a pH of 5 or greater and/or greater than 5.2 and/or greater than 5.5 and/or greater than 6 and/or less than 10 and/or less than 9 and/or less than 8 and/or less than 7 as measured according to the pH Test Method described herein prior to contacting the fibrous structure.

The pH of the liquid composition may be impacted by the fibrous structure, for example the fiber composition of the fibrous structure. The liquid composition may exhibit a pH of less than 4.55 and/or less than 4.3 and/or less than 4.1 and/or less than 4 and/or less than 3.8 and/or greater than 2 and/or greater than 2.5 and/or greater than 3 and/or greater than 3.5 as measured according to the pH Test Method described herein after being extracted from the fibrous structure.

Table 1 below shows the pH of the liquid composition after being extracted from the fibrous structure of the present invention and known wet wipes.

TABLE 1

| | pH of Liquid |
|---|---|
| | Composition |
| | Extracted from |
| Wet Wipe | Wet Wipe |
| Invention Example 1 | 4.3 |
| Invention Example 2 | 4.3 |
| Invention Example 3 | 4.3 |
| Invention Example 4 | 4.3 |
| Invention Example 5 | 4.3 |
| Invention Example 6 | 4.3 |
| Charmin Freshmates (currently marketed) | 4.62 |
| Kleenex Cottonelle Fresh | 5.03 |
| Walgreens Flushable Moist Wipes | 5.09 |
| Walmart Natural Choice Flushable Moist Wipes | 5.19 |
| Kroger Nice n Soft Flushable Moist Wipes | 5.05 |
| Meijer Flushable Moist Wipes | 5.23 |
| Target Up&Up Flushable Moist Wipes | 5.04 |
| Scott Wipes | 5.08 |

In one example, the liquid composition comprises an alcohol. In another example, the liquid composition comprises a perfume. In still another example, the liquid composition comprises a preservative.

“% Saturation” also equivalently referred to as “saturation loading” as used herein means the amount of a liquid composition applied to a fibrous structure to form a wet wipe. In general, the amount of the liquid composition applied to a fibrous structure according to the present invention may be chosen in order to provide maximum benefits to the wet wipe. Saturation loading, often expressed as percent saturation, is defined as the percentage of the dry fibrous structure's mass that the liquid composition mass represents. For example, a saturation load of 1.0 (equivalently 100% saturation) indicates that the mass of the liquid composition contained in/on the fibrous structure is equal to the fibrous structure mass whereas a saturation load of 1.5 (equivalently 150% saturation) indicates that the mass of the liquid composition contained in/on the fibrous structure is 1.5 times the fibrous structure mass.

The wet wipes and/or fibrous structures of the present invention may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the wet wipes and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The wet wipes of the present invention may exhibit an initial total wet tensile strength of less than 3000 g/in and/or less than 2500 g/in and/or less than 2000 g/in and/or less than 1800 g/in and/or less than 1500 g/in and/or less than 1250 g/in and/or greater than 300 g/in and/or greater than 400 g/in and/or greater than 500 g/in and/or greater than 600 g/in as measured according to the Wet Tensile Strength Test Method described herein. In one example, the wet wipes of the present invention may exhibit a total wet tensile strength after 28 days of less than 2000 g/in and/or less than 1800 g/in and/or less than 1500 g/in and/or less than 1250 g/in and/or less than 1000 g/in and/or greater than 100 g/in and/or greater than 200 g/in and/or greater than 300 g/in and/or greater than 400 g/in as measured according to the Wet Tensile Strength Test Method described herein.

The wet wipes of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The wet wipes of the present invention may be in the form of wet wipe rolls. Such wet wipe rolls may comprise a plurality of connected, but perforated sheets of fibrous structure, that are separably dispensable from adjacent sheets.

The wet wipes of the present invention may comprises additives such as softening agents such as silicones and/or quaternary ammonium compounds, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on wet wipes.

In one example, the wet wipe is void (less than 5% and/or less than 3% and/or less than 1% and/or less than 0.5% and/or less than 0.1% by weight of the wet wipe) of any post fibrous structure making applied polymeric binder.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Caliper” as used herein means the macroscopic thickness of a fibrous structure. Caliper is measured according to the Caliper Test Method described herein.

“Bulk” as used herein is calculated as the quotient of the Caliper, expressed in microns, divided by the Basis Weight, expressed in grams per square meter. The resulting Bulk is expressed as cubic centimeters per gram. For the products of this invention, Bulks can be greater than about 3 cm³/g and/or greater than about 6 cm³/g and/or greater than about 9 cm³/g and/or greater than about 10.5 cm³/g up to about 30 cm³/g and/or up to about 20 cm³/g. The products of this invention derive the Bulks referred to above from the basesheet, which is the sheet produced by the tissue machine without post treatments such as embossing. Nevertheless, the basesheets of this invention can be embossed to produce even greater bulk or aesthetics, if desired, or they can remain unembossed. In addition, the basesheets of this invention can be calendered to improve smoothness or decrease the Bulk if desired or necessary to meet existing product specifications.

“Density” as used herein is calculated as the quotient of the Basis Weight expressed in grams per square meter divided by the Caliper expressed in microns. The resulting Density is expressed as grams per cubic centimeters (g/cm³ or g/cc). In one example, the Densities can be greater than 0.05 g/cm³ and/or greater than 0.06 g/cm³ and/or greater than 0.07 g/cm³ and/or less than 0.10 g/cm³ and/or less than 0.09 g/cm³ and/or less than 0.08 g/cm³. In one example, a fibrous structure of the present invention exhibits a density of from about 0.055 g/cm³ to about 0.095 g/cm³.

“Machine Direction” or “MD” as used herein means the direction parallel to the flow of the fibrous structure through the fibrous structure making machine and/or wet wipe manufacturing equipment.

“Cross Machine Direction” or “CD” as used herein means the direction parallel to the width of the fibrous structure making machine and/or wet wipe manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply wet wipe. It is also contemplated that an individual, integral fibrous structure can effectively form a multi-ply fibrous structure, for example, by being folded on itself.

“Embossed” as used herein with respect to a fibrous structure means a fibrous structure that has been subjected to a process which converts a smooth surfaced fibrous structure to a decorative surface by replicating a design on one or more emboss rolls, which form a nip through which the fibrous structure passes. Embossed does not include creping, microcreping, printing or other processes that may impart a texture and/or decorative pattern to a fibrous structure.

### Fibrous Structure

In one example of the present invention, the fibrous structure of the wet wipe comprises greater than 20% and/or greater than 40% and/or greater than 50% and/or greater than 75% and/or greater than 90% and/or to about 100% by weight on a total dry fiber basis of pulp fibers, such as hardwood and/or softwood pulp fibers.

The fibrous structure may comprise a surface comprising a surface pattern. The surface pattern may comprise a non-random, repeating pattern. The surface pattern may comprise a formed surface pattern such as resulting from a patterned belt and/or belt/fabric combination. In another example, the fibrous structure may be an embossed fibrous structure that comprises one or more embossments, such as imparted by passing the fibrous structure (prior to and/or after application of a liquid composition) through an embossing nip. The one or more embossments may comprise line art embossments and/or dot embossments and/or other non-line art embossments.

In one example, the fibrous structure of the present invention may comprise two or more regions that are different from one another with respect to their specific level of wet tensile strength and/or resistance to disperse.

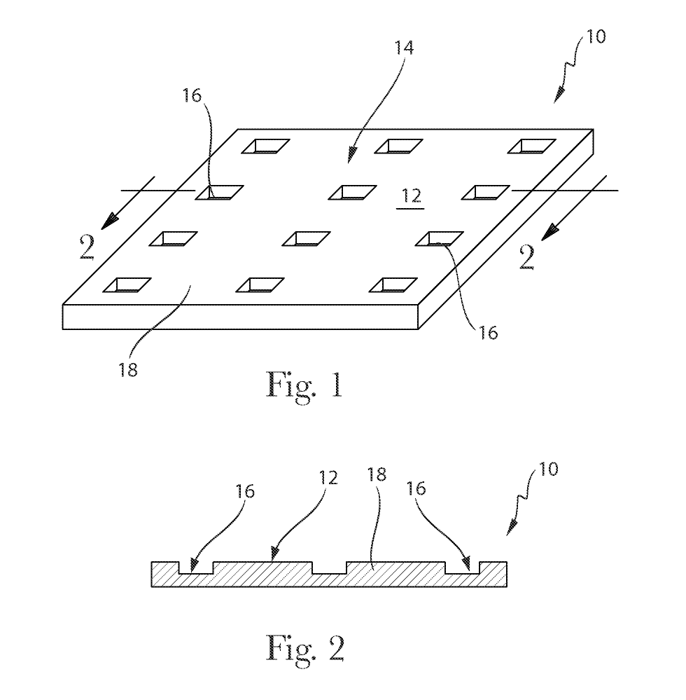

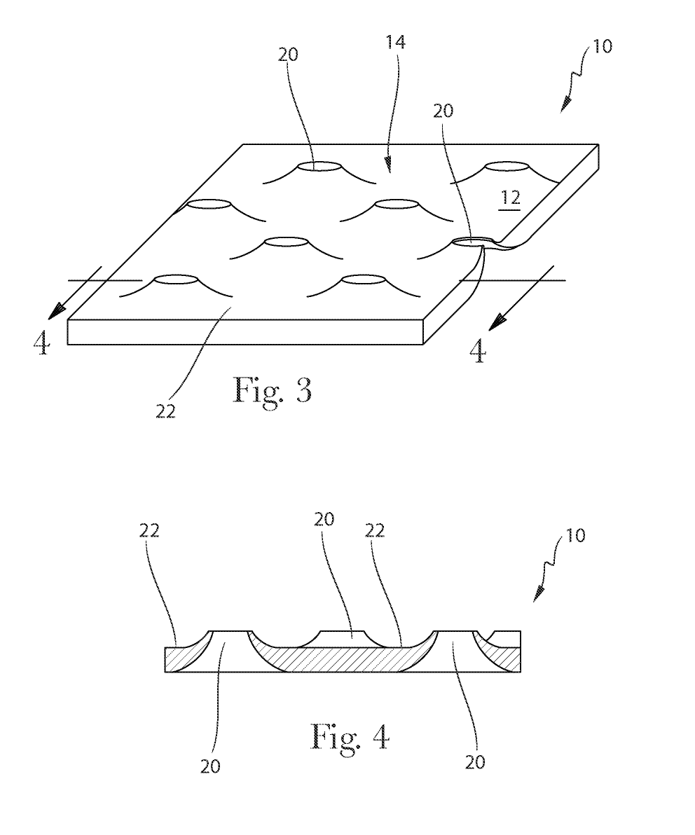

As shown in FIGS. 1 and 2, a fibrous structure 10 according to the present invention may comprise a surface 12 comprising a surface pattern 14. The surface pattern 14 may include two or more different regions. In one example, the surface pattern 14 includes discrete, higher density regions 16 and a lower density region 18 compared to the discrete, higher density regions 16. The lower density region 18 may be in the form of a continuous or substantially continuous network surrounding the discrete, higher density regions 16. In one example, the discrete, higher density regions 16 comprise greater than 6% to about 65% of the surface pattern. In another example, the surface pattern 14 comprises from about 8 to about 400 discrete, higher density regions 16. The discrete, higher density regions 16 may comprise any shape or combination of shapes, for example, circles, triangles, diamonds, trapezoids, squares, rectangles, parallelograms, rhombuses, stars, pentagons, hexagons, and octagons. Without wishing to be bound by theory, it is believed that the lower density region 18 disperses more readily than the higher density regions 16. However, as shown in FIGS. 3 and 4, the fibrous structure 10 of the present invention may comprise a surface 12 having a surface pattern 14 that includes discrete, lower density regions 20, sometimes referred to as “pillows” and a higher density region 22, sometimes referred to as a “knuckle.” The higher density region 22 may be in the form of a continuous or substantially continuous network surrounding the discrete, lower density regions 20.

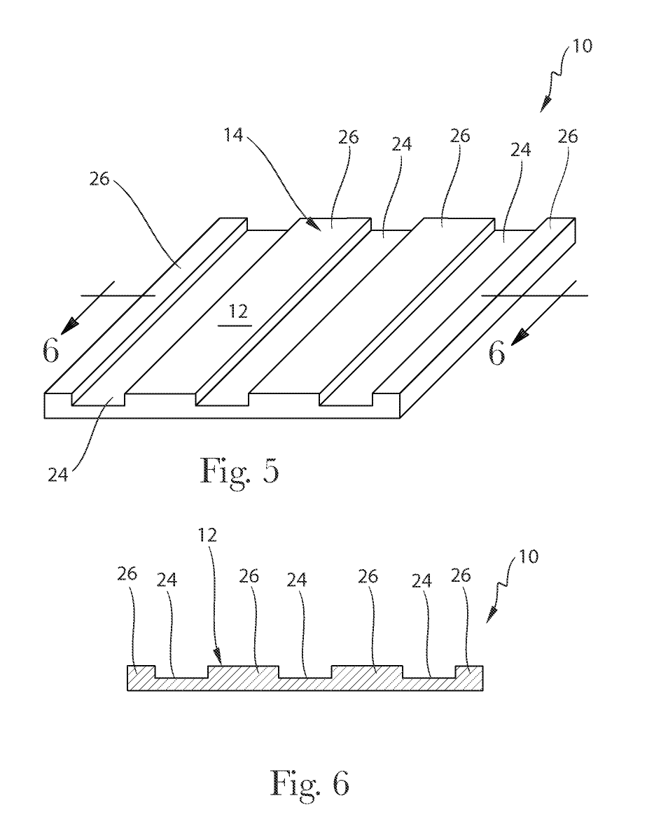

In another example of the present invention as shown in FIGS. 5 and 6, a fibrous structure 10 may comprise a surface 12 having a surface pattern 14. The surface pattern 14 may comprise discrete, higher density regions 24 and discrete, lower density regions 26.

In another example of the present invention, the fibrous structure comprises two or more regions that exhibit different values of a common intensive property, for example different densities (a region of higher density relative to a region of lower density) and/or different basis weights.

The fibrous structure may be a creped fibrous structure or an uncreped fibrous structure. The fibrous structure may be a fabric and/or belt creped fibrous structure. In addition, the fibrous structure may be a wet molded and/or a wet microcontracted fibrous structure. Further, the fibrous structure may be a through-air-dried fibrous structure or a compressively dewatered fibrous structure, such as a conventional papermaking processed fibrous structure. In one example, the fibrous structure is a non-hydroentangled (non-spunlaced) fibrous structure.

The fibrous structure may comprise a temporary wet strength agent. Suitable temporary wet strength agents include materials that can react with hydroxyl groups, such as on cellulosic pulp fibers, to form hemiacetal bonds that are reversible in the presence of excess water. Suitable temporary wet strength agents are known to those of ordinary skill in the art. Non-limiting examples of temporary wet strength agents suitable for the fibrous structures of the present invention include glyoxylated polyacrylamide polymers, for example cationic glyoxylated polyacrylamide polymers. In one example, the temporary wet strength agent comprises Hercobond® commercially available from Ashland Inc. In another example, the temporary wet strength agent comprises Parez® 750 and/or 745 commercially available from Kemira Chemicals, Inc.

In one example, the temporary wet strength agent exhibits a pH of less the 7 and/or less than 6.5 and/or less than 6 and/or less than 5.5 and/or less than 5 and/or less than 4.5 and/or to about 2.5 and/or to about 3 and/or to about 3.5. In one example, the pH of the temporary wet strength agent is about 4.

Non-limiting examples of temporary wet strength agents made by the methods of the present invention generally have weight average molecular weights of from about 20,000 to about 400,000 and/or from about 50,000 to about 400,000 and/or from about 70,000 to about 400,000 and/or from about 70,000 to about 300,000 and/or from about 100,000 to about 200,000.

The temporary wet strength agents of the present invention impart wet tensile strength properties and wet tensile decay properties to the fibrous structures and/or wet wipes of the present invention.

It has been found that temporary wet strength agents with high weight average molecular weights (i.e. those in excess of 300,000) may decay unacceptably slow for consumer purposes. Further, it has been found that temporary wet strength agents with extremely low weight average molecular weights (i.e. those less than 70,000) may have very low wet strength and may not be optimal as temporary wet strength agents for fibrous structures and/or wet wipes.

Non-limiting examples of temporary wet strength agents in accordance with the present invention include temporary wet strength agents having the formula:

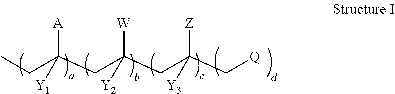

wherein: A (the moiety present on the co-crosslinking monomeric unit) is independently an electrophilic moiety, non-limiting examples of which include the following:

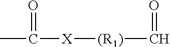

Z (the moiety present on the reversible, homo-crosslinking monomeric unit) is independently a nucleophilic moiety capable of forming an unstable covalent bond with the electrophilic moiety, non-limiting examples of which include the following:

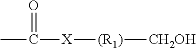

and X is independently —O—, —NH—, or —NCH₃—; and R₁ is a substituted or unsubstituted aliphatic group; Y₁, Y₂, and Y₃ are independently —H, —CH₃, or a halogen; Q is a cationic moiety; and W is a non-nucleophilic moiety or a nucleophilic moiety that does not form a stable covalent bond with the electrophilic moiety. Non-limiting examples of moieties for W include water-soluble N,N-dialkyl acrylamide moieties and/or water-soluble carboxylic acid moieties.

The mole percent of a ranges from about 1% to about 20%, preferably from about 2% to about 15%, the mole percent of b ranges from about 0% to about 60%, preferably from about 0% to about 45%, the mole percent of c ranges from about 10% to about 90%, preferably from about 30% to about 80%, and d ranges from about 1% to about 40%, preferably from about 2% to about 20%, more preferably from about 5% to about 12%.

Unless otherwise expressly specified, values for a, b, c, and d shall be mole percentage values based upon the average number of monomeric units in the polymer backbone of the temporary wet strength agent of the present invention.

The monomeric units of the polymer backbone of the temporary wet strength agent of the present invention may be randomly distributed throughout the polymer in ratios corresponding to the mole percentage ranges described herein.

Each class of monomeric units may include a single monomer or may include combinations of two or more different monomers within that class. The mole percent of each monomeric unit within a class of monomeric units may be independently selected.

In one example, the fibrous structure comprises greater than 5% and/or greater than 10% and/or greater than 25% and/or greater than 40% and/or greater than 50% and/or to about 90% and/or to about 80% and/or to about 70% by weight of the liquid composition.

### Wet Wipe

The fibrous structures of the present invention may be saturation loaded with a liquid composition to form a wet wipe. The loading may occur individually, or after the fibrous structures are placed in a stack, such as within a liquid impervious container or packet. In one example, the fibrous structures may be saturation loaded with from about 1.5 g to about 6.0 g and/or from about 2.5 g to about 4.0 g of liquid composition per g of fibrous structure.

The wet wipes of the present invention may be placed in the interior of a container, which may be liquid impervious, such as a plastic tub or a sealable packet, for storage and eventual sale to the consumer. The wet wipes may be folded and stacked. The wet wipes of the present invention may be folded in any of various known folding patterns, such as C-folding, Z-folding and quarter-folding. Use of a Z-fold pattern may enable a folded stack of wet wipes to be interleaved with overlapping portions. Alternatively, the wet wipes may include a continuous strip of fibrous structure which has perforations between each wet wipe and which may be arranged in a stack or wound into a roll for dispensing, one after the other, from a container, which may be liquid impervious.

The wet wipes of the present invention may further comprise prints, which may provide aesthetic appeal. Non-limiting examples of prints include figures, patterns, letters, pictures and combinations thereof.

In one example, the wet wipe of the present invention exhibits an in-use total wet tensile strength of greater than 300 g/in and/or greater than 400 g/in and/or greater than 500 g/in and/or greater than 600 g/in and/or less than 2500 g/in and/or less than 2000 g/in and/or less than 1500 g/in and/or less than 1000 g/in as measured by the Wet Tensile Strength Test Method described herein.

In another example, the wet wipe of the present invention exhibits a 12.5 mm Screen Retention Value at 3 hours of less than 50% and/or less than 40% and/or less than 30% and/or 20% and/or less than 15% and/or less than 10% and/or less than 5% as measured according to the Shake Flask Test Method described herein.

In another example, the wet wipe of the present invention exhibits a 3 mm Screen Retention Value at 3 hours of less than 50% and/or less than 40% and/or less than 30% and/or less than 25% and/or less than 20% and/or less than 15% and/or less than 10% and/or less than 5% as measured according to the Shake Flask Test Method described herein.

Table 2 below shows the Screen Retention Values for several invention example wet wipes that comprised 7 pounds/ton of temporary wet strength agent (Hercobond® 1194), a first prototype (Prototype 1) that was similar to the invention example wet wipes except it contained 12 pounds/ton temporary wet strength agent (Hercobond® 1194), two prototypes (Prototypes 2 and 3) that were similar to the invention example wet wipes except they contained a permanent wet strength agent (Kymene®) rather than a temporary wet strength agent, and known wet wipes.

TABLE 2

| | 12.5 mm | |
|---|---|---|
| | Screen | 3 mm Screen |
| | Retention | Retention |
| | Value (%) | Value (%) |
| Wet Wipe | After 3 hours | After 3 hours |
| Invention Example 1 | 0 | 19 |
| Invention Example 2 | 0 | 0 |
| Invention Example 3 | 0 | 0 |
| Invention Example 4 | 0 | 5.5 |
| Invention Example 5 | 0 | 0 |
| Invention Example 6 | 2.4 | 20.1 |
| Charmin Freshmates | 83.2 | 70 |
| (currently marketed) | | |
| Prototype 1 | — | 70 |
| Prototype 2 | 92 | 92 |
| (permanent wet | | |
| strength agent) | | |
| Prototype 3 | 95 | 95 |
| (permanent wet | | |
| strength agent) | | |
| Kleenex Cottonelle | 0 | 28 |
| Fresh | | |
| Walgreens Flushable | 90.6 | 0 |
| Moist Wipes | | |
| Walmart Natural | — | — |
| Choice Flushable | | |
| Moist Wipes* | | |
| Kroger Nice n Soft | 90.8 | 0 |
| Flushable Moist | | |
| Wipes | | |
| Meijer Flushable | — | — |
| Moist Wipes* | | |
| Target Up&Up | — | — |
| Flushable Moist | | |
| Wipes* | | |
| Scott Natural Wipes | 23.0 | 5.1 |
| Unicharm Wipes | — | 12 |

*Expect the values for these products to be consistent with the values of the Walgreens and the Kroger products since their fibrous structures are apparently supplied by the same supplier; namely Rockline Industries.

### Method for Making Fibrous Structure

Any suitable process known in the art may be used to make the fibrous structure of the present invention. In one example, the fibrous structure of the present invention is made using a wet-laid fibrous structure making process.

The fibrous structure of the present invention may be made by any suitable process known in the art so long as the fibrous structure meets the wet tensile strength and/or dispersibility requirements described herein. In one example, the fibrous structure of the present invention is made using a wet-laid fibrous structure making process.

In one example, a method for making a wet wipe comprising the steps of:
a. providing a fibrous structure, for example a fibrous structure according to the present invention; and
b. contacting the fibrous structure with a liquid composition, for example a fibrous structure according to the present invention such that a wet wipe, for example a wet wipe according to the present invention is produced.

In still another example, a method for making a wet wipe comprising the steps of:
a. providing a fibrous structure, for example a fibrous structure according to the present invention; and
b. contacting the fibrous structure with a liquid composition, for example a liquid composition according to the present invention such that the pH of the liquid composition after being extracted from the fibrous structure is less than 4.55 as measured according to the pH Test Method to produce a wet wipe, for example a wet wipe according to the present invention.

In yet another example, a method for making a wet wipe comprising the steps of:
a. providing a fibrous slurry comprising a plurality of fibers and a temporary wet strength agent; and optionally, a dry strength agent;
b. depositing the fibrous slurry onto a forming wire to form an embryonic web;
c. transferring the embryonic web to a patterned belt to impart a surface pattern to the embryonic web;
d. drying the embryonic web to form a fibrous structure, for example a fibrous structure according to the present invention; and
e. contacting the fibrous structure with a liquid composition, for example a liquid composition according to the present invention to form a wet wipe, for example a wet wipe according to the present invention.

In yet another example, a method for making a wet wipe comprising the steps of:
a. providing a fibrous slurry comprising a plurality of fibers and a temporary wet strength agent; and optionally, a dry strength agent;
b. depositing the fibrous slurry onto a forming wire to form an embryonic web;
c. transferring the embryonic web to a patterned belt to impart a surface pattern to the embryonic web;
d. drying the embryonic web to form a fibrous structure, for example a fibrous structure according to the present invention; and
e. contacting the fibrous structure with a liquid composition, for example a liquid composition according to the present invention to form a wet wipe, for example a wet wipe according to the present invention wherein the pH of the liquid composition after being extracted from the fibrous structure is less than 4.55 as measured according to the pH Test Method, is provided.

The fibrous structure may be any suitable fibrous structure. In one example, the fibrous structure comprises a wet-laid fibrous structure.

In another example, the fibrous structure comprises greater than 75% and/or greater than 80% and/or greater than 90% and/or greater than 95% and/or to about 100% by weight of pulp fibers.

The patterned belt of the present invention may be a molding member. A “molding member” is a structural element that can be used as a support for an embryonic web comprising a plurality of cellulosic fibers and a plurality of synthetic fibers, as well as a forming unit to form, or “mold,” a desired microscopical geometry of the wet wipe of the present invention. The molding member may comprise any element that has fluid-permeable areas and the ability to impart a microscopical three-dimensional pattern to the structure being produced thereon, and includes, without limitation, single-layer and multi-layer structures comprising a stationary plate, a belt, a woven fabric (including Jacquard-type and the like woven patterns), a band, and a roll. In one example, the molding member is a deflection member. The molding member may comprise a surface pattern according to the present invention that is imparted to the wet wipe during the wet wipe making process.

A “reinforcing element” is a desirable (but not necessary) element in some embodiments of the molding member, serving primarily to provide or facilitate integrity, stability, and durability of the molding member comprising, for example, a resinous material. The reinforcing element can be fluid-permeable or partially fluid-permeable, may have a variety of embodiments and weave patterns, and may comprise a variety of materials, such as, for example, a plurality of interwoven yarns (including Jacquard-type and the like woven patterns), a felt, a plastic, other suitable synthetic material, or any combination thereof.

In one example of a method for making a wet wipe of the present invention, the method comprises the step of contacting an embryonic fibrous web with a deflection member (molding member) such that at least one portion of the embryonic fibrous web is deflected out-of-plane of another portion of the embryonic fibrous web. The phrase “out-of-plane” as used herein means that the wet wipe comprises a protuberance, such as a dome, or a cavity that extends away from the plane of the wet wipe. The molding member may comprise a through-air-drying fabric having its filaments arranged to produce linear elements within the wet wipes of the present invention and/or the through-air-drying fabric or equivalent may comprise a resinous framework that defines deflection conduits that allow portions of the wet wipe to deflect into the conduits thus forming linear elements within the wet wipes of the present invention. In addition, a forming wire, such as a foraminous member may be arranged such that linear elements within the wet wipes of the present invention are formed and/or like the through-air-drying fabric, the foraminous member may comprise a resinous framework that defines deflection conduits that allow portions of the wet wipe to deflect into the conduits thus forming linear elements within the wet wipes of the present invention.

The step of contacting the fibrous structure with a liquid composition may comprise spraying, dipping, extruding, and/or printing the liquid composition onto the fibrous structure.

In one example, the liquid composition exhibits a pH of greater than 5 and/or greater than 5.2 and/or greater than 5.5 and/or greater than 6 and/or less than 10 and/or less than 9 and/or less than 8 and/or less than 7 as measured according to the pH Test Method described herein prior to contacting the fibrous structure.

The liquid composition may exhibit a pH of less than 4.55 and/or less than 4.3 and/or less than 4.1 and/or less than 4 and/or less than 3.8 and/or greater than 2 and/or greater than 2.5 and/or greater than 3 and/or greater than 3.5 as measured according to the pH Test Method described herein after being extracted from the fibrous structure.

In one example, the liquid composition comprises an alcohol. In another example, the liquid composition comprises a perfume. In still another example, the liquid composition comprises a preservative.

Any suitable level of the liquid composition may be delivered to the fibrous structure. In one example, the fibrous structure comprises greater than 5% and/or greater than 10% and/or greater than 25% and/or greater than 40% and/or greater than 50% and/or to about 90% and/or to about 80% and/or to about 70% by weight of the liquid composition.

Any suitable level of the temporary wet strength agent may be added to the fibrous slurry. In one example, the temporary wet strength agent is added to the fibrous slurry at a level of greater than 0.1 and/or greater than 0.5 and/or greater than 1 and/or greater than 3 and/or greater than 5 and/or greater than 6 and/or to less than 12 and/or less than 10 and/or less than 8 pounds/ton of fiber.

Before or after the contacting step, the fibrous structure may converted into a wet wipe.

The fibrous structure may be in a roll form, such as a parent roll from the fibrous structure making process. A roll of fibrous structure may be converted into rolls of wet wipes and/or individual sheets of wet wipes.

In one example a roll of fibrous structure may be unwound and slit into smaller widths of fibrous structures that may then be wound into smaller width rolls, for example 188 mm width rolls.

The rolls of fibrous structure may be loaded into a converting line's unwind stand. The unwind stand may be a center driven unwind stand capable of controlling the tension via speed control through a series of dancers. In one example, the line speed at this stage in the converting line is about 34 m/min The fibrous structure then may pass over the dancers and a tensiometer device that monitors tension of the fibrous structure inline while being converted with real time feedback to the center drive unwind stand to control in process tension monitoring and control. In one example, the inline converting tension of the fibrous structure may be about 1 N.

The fibrous structure may then pass over a liquid composition bar (also referred to as a lotion bar) with minimal contact such that the lotion bar delivers the liquid composition through openings in the lotion bar to a surface of the fibrous structure.

The fibrous structure may then be folded into any suitable fold configuration, such as a Z-fold. This folding step may occur prior to the fibrous structure passing over the liquid composition bar.

In one example, the folded fibrous structure may be cut to desired dimensions to form individual wet wipes. A plurality of the individual wet wipes may be stacked together and then packaged in a container and/or wrapper.

In another example, the folded fibrous structure may be perforated and then wound into a roll of perforated wet wipes, which may be dispensed from the roll as individual wet wipes upon tearing along a perforation.

A container and/or wrapper containing a stack of wet wipes or a roll of wet wipes forms an article of manufacture that may be sold to consumers.

In one example, the fibrous structure making process may be directly coupled or close coupled to the converting line.

In another example, the fibrous structure making process may comprise slitting the fibrous structure prior to moving to the converting line.

### Non-Limiting Example

One example of a process for making a wet wipe is as follows. A wet wipe in accordance with the present invention is prepared using a fibrous structure made by a fibrous structure making machine having a non-layered headbox.

A conventional pulper is used to prepare the hardwood stock chest with eucalyptus fiber having a consistency of about 3.0% by weight to form a thick stock. Separately, a conventional pulper is used to prepare the softwood stock chest with northern softwood kraft (NSK) fiber having a consistency of about 3.0% by weight to form a thick stock. The NSK fiber is passed through a refiner and is refined to a Canadian Standard Freeness (CSF) of about 650. After refining, a temporary wet strength agent, Hercules Hercobond® 1194 at 1% solids, is added to the NSK thick stock at a rate of about 6.1 pounds per ton of fiber. The refined NSK thick stock and the Eucalyptus thick stock are then combined into a common stock line at an in-line mixer to form a homogeneous thick stock at a proportion of 70% NSK and 30% Eucalyptus.

The homogeneous thick stock is pumped to the fan pump where it is diluted from about 3% consistency to about 0.1% to about 0.2% consistency with process water having a pH of about 5.2 to about 5.5. Once diluted, the homogeneous slurry is pumped to the headbox where the fiber slurry is evenly distributed onto a forming wire (84×78, Albany International) traveling at a velocity of 220 feet per minute to form an embryonic web. The vacuum slots located on the wire table vacuum are used to dewater the embryonic web to a consistency of about 20% to about 25% before entering the wire-to-press transfer zone.

A pickup shoe is used to transfer the embryonic web from the forming wire to a patterned drying belt. The speed of the patterned drying belt is about 200 feet per minute. The drying belt is designed to mold a pattern of substantially discrete high density regions surrounded by a continuous network of low density regions into the embryonic web. The drying belt is formed by casting an impervious resin surface onto a fiber mesh supporting fabric. The supporting fabric is a 98×62 filament, dual layer mesh. The thickness of the resin cast is about 22 mils above the supporting fabric.

While remaining in contact with the patterned drying belt, the web is pre-dried by air blow-through pre-dryers to a fiber consistency of about 60% by weight.

After the pre-dryers, the semi-dry web is transferred to the Yankee dryer via pressure roll nip and adhered to the surface of the Yankee dryer with a sprayed a creping adhesive coating. The creping adhesive is an aqueous dispersion with the actives consisting of Georgia Pacific's Unicrepe 457T20 and Vinylon Works' Vinylon 8844 at a blend of about 25%/75%, respectively. The fiber consistency is increased to about 97% before the web is dry-creped from the Yankee with a doctor blade.

The doctor blade has a bevel angle of about 45 degrees and is positioned with respect to the Yankee dryer to provide an impact angle of about 101 degrees. The Yankee dryer is operated at a temperature of about 350° F. (177° C.) and a speed of about 200 feet per minute. The fibrous structure is wound into a parent roll using a surface driven reel drum having a surface speed of about 191 feet per minute.

The parent roll width is slit to a width of 188 millimeters as it rewound into a “chip” roll. The “chip” is placed onto the unwind stand and the fibrous web is threaded through a wet wipe converting line. The speed of the fibrous web through the process is 34 meters per minute while the fibrous web tension is controlled to about 1 Newton. The fibrous web then passes over a lotion bar (liquid composition bar) where the fibrous web absorbs the lotion (liquid composition) at a saturation level of about 150% to about 200%.

The lotion-saturated fibrous web is then folded in a Z-fold configuration (ribbon), cut to length, stacked, and optionally interleaved to form a stack of wet wipes, which then are placed into a wrapper or container, such as a tub.

### Test Methods

Unless otherwise indicated, all tests described herein including those described under the Definitions section and the following test methods are conducted on samples that have been conditioned in a conditioned room at a temperature of 23° C.±2.2° C. and a relative humidity of 50%±10% for 2 hours prior to the test. All tests are conducted in such conditioned room.

### pH Test Method

In order to measure the pH of a liquid composition present on a wet wipe, the following procedure is used. First, secure a C-clamp's frame in the jaws of a 6 inch table vise. Tighten the table vise so that the C-clamp does not move. The C-clamp should not shift within the table vise as compression is formed between the stationary foot and the adjustable foot of the C-clamp. The feet of the C-clamp have a 1 inch diameter.

Calibrate a digital pH meter (Oakton pH 5, Acorn Series, WD-35613-00 or equivalent) according to the manufacturer's instruction manual. Measurements are made according to the manufacturer's instruction manual.

Wearing latex or rubber gloves, dispense a single sheet of wet wipe from a package or tub of wet wipes being sure that the wet wipe has not dried out too much. Fold the single wet wipe sheet five times (resulting in a 32-ply implement).

Place the folded wet wipe sheet onto the stationary foot of the C-clamp. Turn the adjustment screw for the adjustable foot of the C-clamp until the stationary and adjustable foot of the C-clamp contact the folded wet wipe sheet.

Position a 50 ml beaker under the folded wet wipe sheet and then turn the adjustment screw of the C-clamp to begin compressing the folded wet wipe sheet to cause the liquid composition to flow from the folded wet wipe sheet and collect the liquid composition into the 50 ml beaker.

Repeat the steps of this procedure with additional wet wipes from the package or tub until the level of extricated liquid composition in the 50 ml beaker is sufficient for measuring pH per the pH meter manufacturer's instruction manual.

Measure and record the resulting pH for the wet wipe.

One of ordinary skill in the art will understand how to measure the pH of a liquid composition prior to contacting a fibrous structure and/or a temporary wet strength agent.

### Shake Flask Test Method

To determine the dispersibility of a wet wipe, the following Shake Flask Test is performed. The results of this test show the Screen Retention Value of a wet wipe at various size screens.

Sample Preparation Weigh a wet wipe to be tested. Incubate a wet wipe sample in a 2800 mL baffled Fernbach flask with tap water on a rotary shaker at 150 rpm. After 3 hours the contents of the flask is passed through a sequential series of different sized perforated plates with openings of 12.5 mm, 6 mm, 3 mm, and 1.5 mm Material retained on each plate is recovered, dried at 40° C., and weighed. The percent of material retained is calculated based on the initial weight of the wet wipe. The overall loss of the wet wipe is also calculated.

### Basis Weight Test Method

Basis weight of a fibrous structure and/or wet wipe sample is measured by selecting twelve (12) usable units (also referred to as sheets) of the fibrous structure and/or wet wipe and making two stacks of six (6) usable units each. Perforation, if any, must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 ( usable units ) \times \\ [ 12.25 {in}^{2} ( Area of basis weight pad ) / 144 {in}^{2} ]\end{matrix}}$$

$$Basis Weight ( g \text{/} {m}^{2} ) = \frac{Weight of basis weight pad ( g ) \times 10 \text{,} 000 {cm}^{2} \text{/} {m}^{2}}{\begin{matrix}79.0321 {cm}^{2} ( Area of basis weight pad ) \times \\ 12 ( usable units )\end{matrix}}$$

### Caliper Test Method

To measure the caliper (thickness) of a wet wipe, the following procedure is used. Identify a minimum of 5 different locations on the wet wipe to measure the caliper. Cut the 5 or more portions (replicates) in a dimension greater than the foot of the Caliper Tester (Ono Sokki GS—503 Linear Gauge Sensor with an Ono Sokki DG3610 display or equivalent. May be obtained from Measure-All, Inc. 447 Nilles Road, Fairfield, Ohio 45014). to contact the sample. When testing finished wet wipe product, open a package of wet wipes and randomly select 5 finished wet wipe products and measure immediately in their normal wet state. Place package with remaining product in a resealable plastic bag and seal.

Before using the Caliper Tester, make sure that the pressure foot (a stainless steel circular foot Area: 2500 mm^{2±}50 mm² (56 mm Diameter) and Foot Pressure: 0.501 kPa±0.021) and anvil surfaces are clean, that the calibration of the instrument has been done per the manufacturer's instruction manual, and that the instrument is mounted on a solid level surface free from noticeable vibration, for example a granite base with mounting arm (Chicago Dial Indicator Co. Part No. 608-12-1R or equivalent), which may be obtained from Measure-All, Inc. 447 Nilles Road, Fairfield, Ohio 45014. Calibration should include verification of 0.50110a±0.021 (0.073PSI±0.003) pressure with a balance, verification that the presser foot is level to the base ^{±}0.05 mm, and readings of steel gauge blocks accurate to ^{2±}0.05 mm Zero the thickness gauge as described by the manufacturer.

With the Caliper Tester foot in the up-position, center the sample portion underneath. Lower the foot with the handle at a rate of approximately 3 mm per second. After the foot contacts the sample, wait 5 seconds and record the caliper (thickness) result for each sample portion (replicate).

1) Calculate the Mean for replicates used for measured sample.

2) Report Thickness in mm to the nearest 0.01 mm.

Do not use sample portions cut with a die. Do not make thickness readings on creases resulting from folds. Do not make thickness readings on samples with obvious defects such as wrinkles, tears, and holes. Do not handle in areas to be measured. Do not test the same area of a sample portion more than once.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wet wipe that exhibits a 12.5 mm Screen Retention Value at 3 hours of less than 20% and a 3 mm Screen Retention Value at 3 hours of less than 25% as measured according to the Shake Flask Test Method described herein.

2. The wet wipe according to claim 1 wherein the wet wipe exhibits a 12.5 mm Screen Retention Value at 3 hours of less than 15% as measured according to the Shake Flask Test Method described herein.

3. The wet wipe according to claim 1 wherein the wet wipe exhibits a 3 mm Screen Retention Value at 3 hours of less than 20% as measured according to the Shake Flask Test Method described herein.

4. The wet wipe according to claim 1 wherein the wet wipe comprises a liquid composition.

5. The wet wipe according to claim 4 wherein the wet wipe comprises greater than 5% by weight of the liquid composition.

6. The wet wipe according to claim 4 wherein the liquid composition comprises an aqueous composition.

7. The wet wipe according to claim 4 wherein the liquid compositions exhibits a pH of less than 4.55 after being extracted from the wet wipe as measured according to the pH Test Method described herein.

8. The wet wipe according to claim 4 wherein the liquid composition exhibits a pH of 5 or greater prior to contacting the wet wipe as measured according to the pH Test Method described herein.

9. The wet wipe according to claim 1 wherein the wet wipe exhibits an in-use total wet tensile of greater than 300 g/in as measured according to the Wet Tensile Test Method described herein.

10. The wet wipe according to claim 1 wherein the wet wipe comprises a surface comprising a surface pattern.

11. The wet wipe according to claim 10 wherein the surface pattern comprises a non-random, repeating pattern.

12. The wet wipe according to claim 1 wherein the wet wipe comprises two or more regions that exhibit different values of a common intensive property.

13. The wet wipe according to claim 1 wherein the wet wipe comprises a creped wet wipe.

14. The wet wipe according to claim 1 wherein the wet wipe comprises an uncreped wet wipe.

15. The wet wipe according to claim 1 wherein the wet wipe comprises one or more embossments.

16. The wet wipe according to claim 1 wherein the wet wipe is a non-hydroentangled wet wipe.

17. The wet wipe according to claim 1 wherein the wet wipe comprises greater than 50% by weight of pulp fibers.

18. A method for making a wet wipe, the method comprising the steps of:
a. providing a fibrous structure; and
b. contacting the fibrous structure with a liquid composition such that a wet wipe that exhibits a 12.5 mm Screen Retention Value at 3 hours of less than 20% and a 3 mm Screen Retention Value at 3 hours of less than 20% as measured according to the Shake Flask Test Method described herein.

19. The method according to claim 18 wherein the fibrous structure is a wet-laid fibrous structure.

20. An article of manufacture comprising a container that houses a wet wipe that exhibits a 12.5 mm Screen Retention Value at 3 hours of less than 20% and a 3 mm Screen Retention Value at 3 hours of less than 25% as measured according to the Shake Flask Test Method described herein.
